(19) United States
(12) Patent Application Publication
(10) Pub. No.: US 2015/0292899 A1
(43) Pub. Date: Oct. 15, 2015

(54) NAVIGATION DEVICE AND NAVIGATION SYSTEM

(71) Applicants: DENSO International America, Inc., Southfield, MI (US); DENSO CORPORATION, Kariya-city (JP)

(72) Inventors: Katsumi Ohashi, Torrance, CA (US); Tohru Iwama, Irvine, CA (US)

(21) Appl. No.: 14/518,354

(22) Filed: Oct. 20, 2014

Related U.S. Application Data
(60) Provisional application No. 61/977,380, filed on Apr. 9, 2014.

(51) Int. Cl. G01C 21/36

(52) U.S. Cl. CPC G01C 21/3667

(57) ABSTRACT

A controller retrieves a home area information related to a home area of a user. A communicator downloads a home area map image, which is generated according to the home area information to exclude a map image out of the home area. A storage stores the home area map image. A display indicates the home area map image.

### CROSS-REFERENCE TO RELATED APPLICATION

The application claims the benefit of U.S. Provisional Application No. 61/977,380, filed on Apr. 9, 2014. The entire disclosures of the above application are incorporated herein by reference.

### TECHNICAL FIELD

The present disclosure relates to a navigation device and a navigation system.

### BACKGROUND

Conventionally, a navigation device such as an in-vehicle device is employed to guide a user to a destination. A navigation device may store map data to indicate a map image including a route to a destination and a location of a vehicle. The navigation device may update map data by downloading the map data from a data medium and/or a data center. It may be desirable to update the map data on a regular basis while reducing a total volume of downloaded map data.

When a vehicle is traveling, a navigation device may perform a guidance operation, such as turn-by-turn guidance. While performing the guidance operation, the navigation device may communicate with a data center via a mobile device, such as a cellular phone, to download information for the guidance operation. It may be concerned that the guidance operation may be undesirably disrupted if the communication is interrupted.

### SUMMARY

It is an object of the present disclosure to produce a navigation device. It is another object to produce a navigation system including a navigation device communicable with a data center to retrieve a map image.

According to an aspect of the preset disclosure, a navigation device comprises a controller configured to retrieve a home area information related to a home area of a user. The navigation device further comprises a communicator configured to download a home area map image, which is generated according to the home area information to exclude a map image out of the home area. The navigation device further comprises a storage configured to store the home area map image. The navigation device further comprises a display configured to indicate the home area map image.

According to another aspect of the preset disclosure, a navigation device comprises a controller configured to receive a destination. The navigation device further comprises a storage configured to store a map image. The navigation device further comprises a communicator configured to download at least one cutout image when the destination is out of the map image, wherein the at least one cutout image is substantially out of the map image, wherein the at least one cutout image includes at least a part of a route to the destination. The navigation device further comprises a display configured to indicate the cutout image.

According to another aspect of the preset disclosure, a navigation system comprises a device configured to receive a home area information related to a home area of a user. The navigation system further comprises a data center configured to receive the home area information from the device and to generate a home area map image according to the home area information to exclude a map image out of the home area. The device is further configured: to download the home area map image from the data center; to store the home area map image; and to indicate the home area map image.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram showing an overview of a navigation system;

FIG. 2 is a first diagram showing a data flow among components and showing processings of the navigation system;

FIG. 3 is a flowchart showing a processing of home area information retrieval;

FIG. 4 is a flowchart showing a processing of home area map image generation;

FIG. 5A is an image showing a home area map of a user A, and 5B is an image showing a home area map of a user B;

FIG. 6 is a second diagram showing a data flow among components and showing processings of the navigation system;

FIG. 7 is a flowchart showing a processing of data generation;

FIG. 8 is a view showing a regional map image including the home area and a small regional map image;

FIG. 9 is a view showing cutout map images clipped out of a regional map image;

FIG. 10 is a flowchart showing a processing of cutout map indication;

FIGS. 11A to 11D are views showing cutout map images according to a first embodiment; and

FIGS. 12A to 12D are views showing cutout map images according to a second embodiment.

### DETAILED DESCRIPTION

### First Embodiment

(System Configuration)

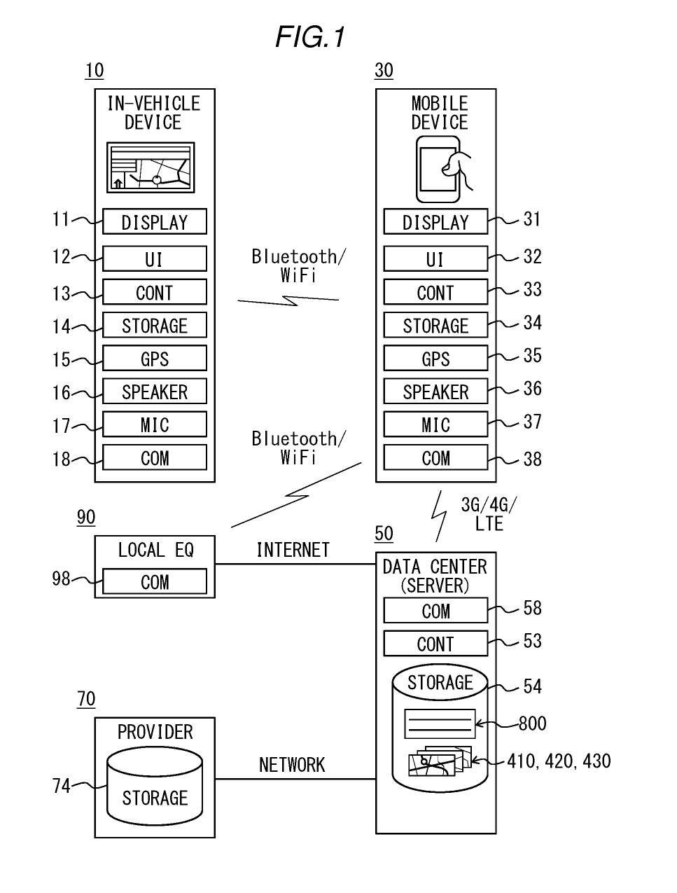

FIG. 1 shows an example of a navigation system. An in-vehicle device 10 is, for example, a car-mounted navigation device such as a head unit. The in-vehicle device 10 is equipped with components such as a display 11, a user interface 12, a controller 13, a storage device 14, a GPS (global positioning system) device 15, a speaker 16, a microphone 17, and/or the like. The components of the in-vehicle device 10 may be data-linked with each other via an internal communication bus. The display 11 is a color dot matrix screen such as a liquid crystal display (LCD) or an organic electroluminescence (O-EL) device. The display 11 indicates a color image. The user interface 12 is an input device such as a mechanical switch or a touch screen equipped on the display 11. The user interface 12 receives entry of information from a user and transmits signals to the controller 13 corresponding to the entered information. The controller 13 is a microcomputer including a CPU, a RAM, a ROM, an I/O device, and/or the like. The storage device 14 is, for example, a solid state drive and/or a hard disk drive. The storage device 14 is configured to store various data such as map data and/or guidance information. The GPS device 15 is configured to communicate with a satellite navigation system and to retrieve various information such as coordinates of the vehicle. The speaker 16 outputs audible information, such as voice, for implementing a guidance operation along a route to a destination. The microphone 17 receives user's voice and may accept user's voice instruction.

The in-vehicle device 10 is further equipped with a communicator 18. The communicator 18 may be a wireless communication device in compliance with a wireless technology standard, such as Wireless Fidelity (WiFi: IEEE 802. 11a/b/n) and/or Bluetooth, to enable short-distance communications for exchanging data with an external device over relatively a short distance, for example, up to 100 meters.

The in-vehicle device 10 is configured to perform route navigation. Specifically, the in-vehicle device 10 shows a map image on the display 11 and a route toward a destination on the map image thereby to guide a user (driver) toward a destination.

A mobile device 30 is, for example, a cellular phone such as a smart phone. The mobile device 30 is equipped with components such as a display 31, a user interface 32, a controller 33, a storage device 34, a GPS device 35, a speaker 36, a microphone 37, and/or the like. The components of the mobile device 30 may have similar configurations to those of the in-vehicle device 10.

The mobile device 30 further includes a communicator 38. The communicator is a wireless communication device in compliance with a mobile telecommunication technology, such as 3G standard, 4G standard, and/or LTE standard to enable long-distance communications. The communicator 38 is for exchanging data with an external device, such as a mobile base station, over relatively a long distance, for example over several kilometers. The communicator 38 is further configured to implement short-distance communications, similarly to the in-vehicle device 10.

The mobile device 30 may be configured to show icons on the display 31. Each icon may be associated with a specific function and/or application such as phone call, short message, social networking service, and/or the like.

A data center 50 is, for example, a ground facility including a communicator 58 and data servers, which are internally communicated with each other via data communication network. The communicator 58 may have a wired channel and a wireless channel. The wired channel may have multiple channels connected with Internet and a data communication network, respectively. The wired channel may be communicated with various land communication stations, such as a service provider, via the data communication network. The wireless channel may be in compliance with a mobile telecommunication technology, such as 3G standard, 4G standard, and/or LTE standard to enable long-distance communications with the communicator 38 of the mobile device 30 through a relay station (not shown). The data center 50 includes data servers each including a controller 53 and a storage device 54. The controller 53 is, for example, a microcomputer array including multiple microprocessors and configured to execute a large-scale processing greater than the controllers 13 and 33 of the in-vehicle device 10 and the mobile device 30. The storage device 54 may be a mass-storage device such as a hard disk array configured to store large-scale data greater than the data stored in storage devices 14 and 34 of the in-vehicle device 10 and the mobile device 30.

A service provider 70 for a map service is connected with the data center 50 via the data communication network. The service provider 70 may be an external facility outside the data center 50. The network may be a secured exclusive transmission line or may be Internet. The service provider 70 may include data servers each including a storage device 74. The storage device 14 may be a mass-storage array storing service information such as map data. The service provider 70 may process a large volume of data including, for example, high-definition map data in a wide area such as entire world, entire United States, entire Europe, and/or the like. The map data may be associated with a large quantity of attribute information, such as road regulations and/or properties of land objects.

The service provider 70 may gather differential information related to recent change in land objects. The gathered differential information may be related to, for example, newly constructed, modified, closed, or demolished roads and land facilities. The gathered information may be further related to, for example, change road regulations. The service provider 70 may timely provide the differential information to the data center 50.

A local equipment 90 may be a communication device such as a wireless router equipped, for example, at home or at work place of the user. The local equipment 90 may include a communicator 98 having a wired channel and a wireless channel. The wired channel is communicated with the data center 50 via, for example, Internet. The wireless channel is configured to perform short-distance communications such as WiFi and/or Bluetooth. When a user is at home or at workplace, the user is enabled to communicate with Internet by using the mobile device 30 via WiFi communications and/or Bluetooth communications provided by the local equipment 90.

The short-distance communications may have a constraint of communicable distance. To the contrary, the short-distance communications may be exchangeable a large volume of data at low cast. The mobile device 30 may be communicable with the in-vehicle device 10 via the short-distance communications, for example, when the mobile device 30 is taken by the user in the vehicle and/or when the vehicle is parked close to the home or the work place. The mobile device 30 may be communicable with the local equipment 90 via the short-distance communications when, for example, the mobile device 30 is taken by the user at home or in the work place and/or when the user parks the vehicle close to the home or the work place.

The mobile device 30 may be communicable with the data center 50 via the long-distance communications regularly.

(Examples of Operation)

As follows, examples of operations according to the present disclosure will be described. In the following examples, the in-vehicle device 10 is communicable with the mobile device 30 via Bluetooth as an example of the short-distance communications. The mobile device 30 is communicable with the local equipment 90 via WiFi as an example of the short-distance communications. The mobile device 30 is further communicable with the data center 50 via LTE as an example of the long-distance communications. The local equipment 90 is communicable with the data center 50 via Internet as an example of network. The methods for communications are not limited to the present example and may be arbitrarily selectable.

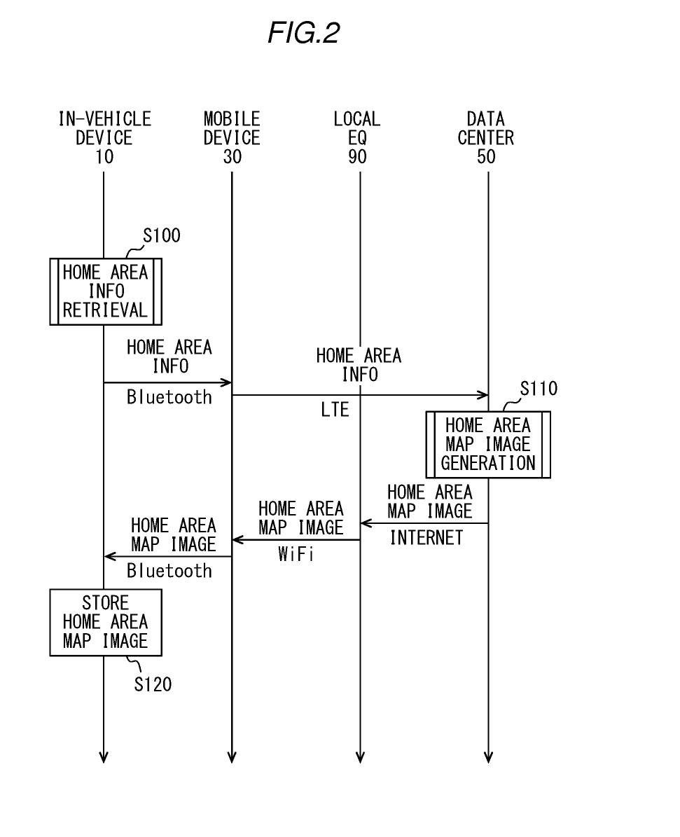

As follows, operation related to a home area map of the user will be described. As shown in FIG. 2, at S100, the in-vehicle device 10 executes home area information retrieval to retrieve home area information about the home area of the user. The home area may be a daily activity area including the user's home and the user's working place between which the user may daily commute. The home area information may include a geographic property of the home area required to specify its location, its boundary, and/or its size. The home area may be defined with an aggregation of geographical sections. In this case, the home area information may include attributes of each geographical section, such as its coordinates, its boundary, and/or its size.

Subsequently, the in-vehicle device 10 sends the retrieved home area information to the mobile device 30 via Bluetooth. The mobile device 30 sends the received home area information to the data center 50 via LTE.

At S110, the data center 50 executes home area map generation to generate a home area map image according to the received home area information. Subsequently, the data center 50 sends the generated home area map image to the local equipment 90 via Internet. The mobile device 30 receives the home area map image from the local equipment 90 via WiFi. Subsequently, the mobile device 30 sends the received home area map image to the in-vehicle device 10 via Bluetooth. At S120, the in-vehicle device 10 stores the received home area map image in the storage device 14.

The in-vehicle device 10 and the mobile device 30 may exchange the home area information and the home area map image when being in communication with each other via Bluetooth in a case where, for example, the mobile device 30 is taken by the user into the vehicle. The mobile device 30 may receive the home area map image from the local equipment 90, when being in communication via WiFi with the local equipment 90 when, for example, the mobile device 30 is at home or at the work place.

The in-vehicle device 10 may send the home area information through the mobile device 30 to the data center 50 automatically, on a regular basis such as one-day interval, or when a change arises in the home area information.

(Home Area Information Retrieval)

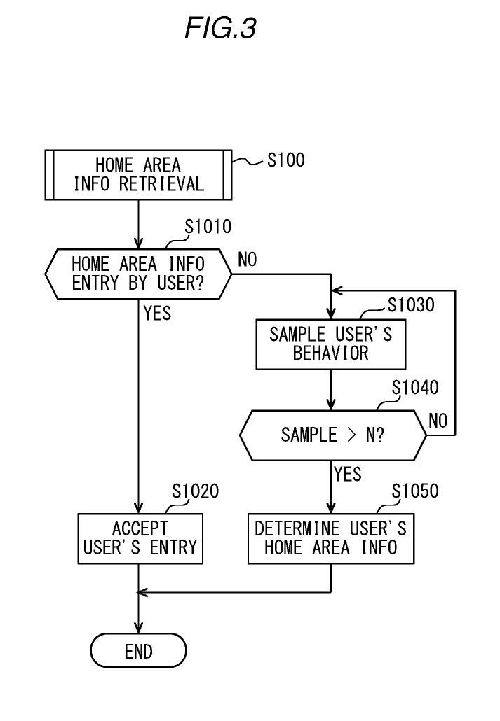

As described above, the in-vehicle device 10 executes the home area information retrieval at S100 in FIG. 2. The home area information retrieval will be described with reference to FIG. 3.

At S1010, the in-vehicle device 10 determines whether to receive user's entry of home area information or whether to learn the home area information. Specifically, the in-vehicle device 10 may inquire the user whether to enter the home area information or to learn the home area information. More specifically, the in-vehicle device 10 may prompt the user to enter the home area information, for example, when being first activated and/or when being reset. The in-vehicle device 10 may implement the inquiry on determination that the in-vehicle device 10 is located at a different place from a previously retrieved home area.

When the in-vehicle device 10 receives operation of the user to enter the home area information, S1010 may make a positive determination (Yes). In this case, at S1020, the in-vehicle device 10 may receive entry of the home area information to specify the home area. The home area information may be an address of the user's home and/or an address of the user's workplace. The user may enter the home area information by specifying the home area on a map image indicated on the in-vehicle device 10.

At S1010, when the in-vehicle device 10 does not receive operation of the user or when the in-vehicle device 10 receives operation of the user to learn the home area information, S1010 may make a negative determination (No). In this case, at S1030, the in-vehicle device 10 starts to sample user's behavior. Specifically, the in-vehicle device 10 may sample locations where the user stays frequently and roads on which the user travels frequently. Thus, the in-vehicle device 10 may learn the behavior of the user in consideration of the tendency of the user based on the sampled locations and roads where the user frequently goes, returns, and travels in daytime, nighttime in weekday, weekend, and holyday. The in-vehicle device 10 may ignore sampled places and roads at significantly small frequency.

At S1040, the in-vehicle device 10 determines whether the number of the samples is greater than a predetermined number N. On positive determination (Yes) at S1040, the processing proceeds to S1050 at which the in-vehicle device 10 determines the user's home area information according to the sampled data. Specifically, the in-vehicle device 10 may select the location, where the user stays most frequently at night, as the user's home. The in-vehicle device 10 may select the location, where the user stays most frequently in daytime in weekdays, as the user's work place. The in-vehicle device 10 may select roads where the user travels most frequently in daytime in weekdays, as a user's commuting route.

The in-vehicle device 10 may indicate a home are map image representing the home area to prompt the user to acknowledge the home area. The user may modify the home area by, for example, dragging a boundary of the home area map image on the display 11.

The in-vehicle device 10 may further retrieve locations, where the user frequently goes, as user's POIs (point of interests, favorite places), such as a supermarket, a golf course, a restaurant, and a coffee shop. The in-vehicle device 10 may retrieve roads, where the user travels to the POIs, to be associated with the POIs.

The in-vehicle device 10 may determine the home area simply to be a predetermined range centered around the home. The in-vehicle device 10 may automatically learn the home area regularly at predetermined time interval or on a specific event such as a user's request.

(Home Area Map Image Generation)

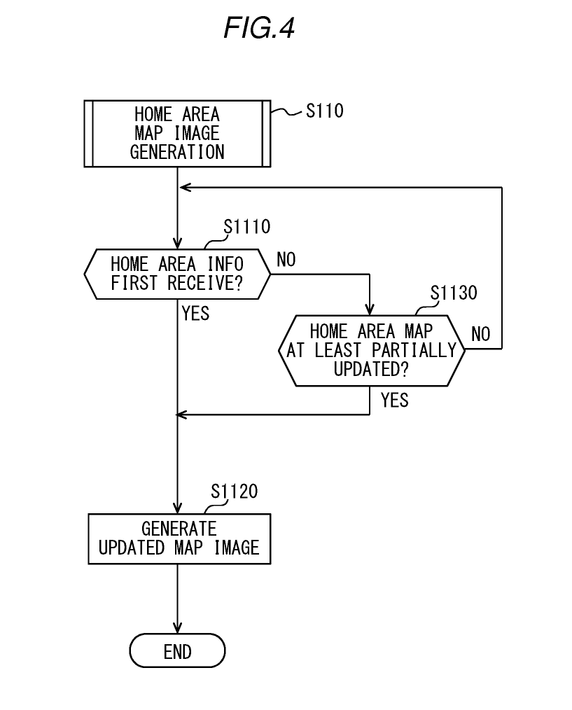

As described above, the data center 50 executes the home area map image generation at S110 in FIG. 1. The home area map image generation will be described with reference to FIG. 4.

At S1110, the data center 50 may determine whether the data center 50 receives the home area information of the in-vehicle device 10 for the first time. On positive determination at S1110, the data center 50 may generate a home area map image at S1120. Originally, the data center 50 may store map data including a wide-area map image, such as a high-definition raw image of entire world. The map data may further include a large quantity of the attribute information. The data center 50 may extract, i.e., clip a section of a map image, which is relevant to the received home area information, from the wide-area map image. The data center 50 may process the section of the map data by, for example, compressing the map data into a map image at a lower resolution in less color tone levels. In this way, the data center 50 may generate the home area map image in a specific compressed format, such as in JPEG format or in PNG format. In addition, the attributed information may be omitted from the generated home area map image. It is noted that, the wide-area map image may be originally in a compressed format.

At S1110 and S1120, when the data center 50 first receives the home area information, the data center 50 may generate the map image without condition. To the contrary, negative determination at S1110 may represent that the data center 50 receives the home area information after the second time. In this case, it may be presumed that the data center 50 has already generated the home area map image at least once and has already sent the home area map image to the in-vehicle device 10 at least once. Therefore, at S1130, the data center 50 may determine whether the home area map corresponding to the home area information is at least partially updated. On positive determination at S1130, the data center 50 may generate the home area map image at S1120. Alternatively, on negative determination at S1130, the data center 50 may not generate the home area map image, on the presumption that the in-vehicle device 10 already has an updated home area map image. In this case, the data center 50 may not generate and may not send the home area map image.

It is noted that, the data center 50 may execute the home area map image generation at S110 on receiving the home area information from the in-vehicle device 10 via the mobile device 30 and/or at a predetermined interval such as one day. The data center 50 may at least regularly determine whether home area map is at least partially updated at S1130 and may generate and send the updated home area map image on positive determination at S1130.

As described above, the in-vehicle device 10 may be configured to retrieve the home area and to receive and store the home area map image corresponding to the retrieved home area. The home area may be distinct among users, and therefore, the home area map image corresponding to the home area may be also distinct among users. That is, the in-vehicle device 10 may be configured to retrieve the home area and to receive and store the home area map image distinctively for different users.

(Examples of Home Area Map Image)

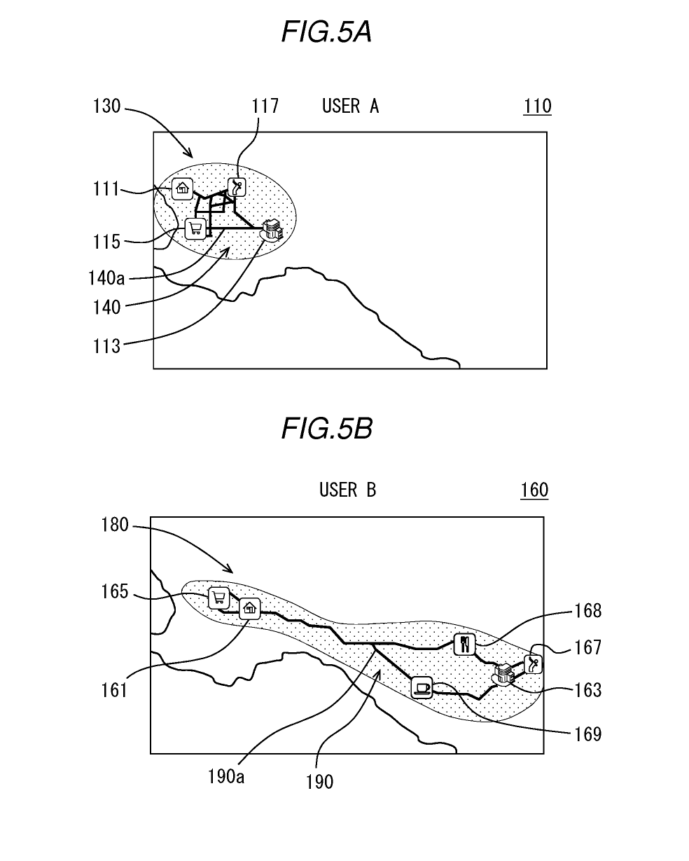

FIG. 5A shows an example of a regional map 110 including a home area map image 130 generated for a user A. FIG. 5B shows an example of a regional map 160 including a home area map image 180 generated for a user B different from the user A. In FIGS. 5A and 5B, icons represent the user's home 111 and 161, the user's work place 113 and 163, and the user's POIs, respectively. Sampled roads 140 and 190 are represented by bold lines. The sampled roads 140 and 190 include commuting routes 140a and 190a. It is noted that, indication of the icons, the commuting routes, and sampled roads in the home area map image is optional.

In FIG. 5A, the home area map image 130 of the user A is in an oval shape and located relatively on the west side (left side) in the regional map 110. The home area map image 130 encompasses a commuting route 140a, sampled roads 140, the home 111, the work place 113, and the POIs including a supermarket 115 and a golf course 117.

In FIG. 5B, the home area map image 160 of the user B is in an elongated shape and located laterally throughout the regional map 160. The home area map image 160 encompasses commuting route 190a, sampled roads 190, the home 161, the work place 163, and the POIs including a supermarket 165, a golf course 167, a restaurant 168, and a coffee shop 169.

The home area may not be necessarily defined to include only the commuting route between the user's home and the user's workplace. As exemplified in FIG. 5B, the home area map image 180 may be determined to encompass the POIs 165 and 167 out of the commuting route 190a. The POIs may be sampled as specific places, where the user frequently uses, or may be manually specified by the user.

As described above, the in-vehicle device 10 may accept entry of the home area information or may learn the home area information distinctively for each of the users A and B. Therefore, the home area information may be suitably defined individually for each of the users A and B. Each of the users A and B may register the entered and/or learned home area information on the in-vehicle device 10 and may restore the home area information.

The in-vehicle device 10 stores the home area map image in the storage device 14. The home area map image may be updated timely in response to transmission of the home area information on a regular basis or when a change arises in the home area information. In daily use, the in-vehicle device 10 may indicate a map image, which is a part of or entire of the stored home area map image corresponding to the home area. In this way, the in-vehicle device 10 may enable indication of the home area map image currently updated, as long as the vehicle travels within the home area, even when the in-vehicle device 10 and/or the mobile device 30 cannot communicate with the data center 50. In addition, the in-vehicle device 10 may store the home area map image, which is limited selectively within the home area. Therefore, the in-vehicle device 10 need not to store a large volume of map data including outside the home area. Thus, the total volume of the storage data may be reduced.

When the vehicle travels within the home area, the in-vehicle device 10 may indicate a vehicle location mark representing the location of the vehicle in the map image. That is, the vehicle location mark may represent the location of the user. It is noted that, the vehicle may travel outside the home area. In such a case, the in-vehicle device 10 may indicate a default wide-area map image with the vehicle location mark, without showing the currently updated map image. When the vehicle travels outside the home area and when the in-vehicle device 10 is communicable with the data center 50 by using the mobile device 30 via LTE, the in-vehicle device 10 may download a map image thereby to update the stored map image with the downloaded map image. In this case, the in-vehicle device 10 may download a map image selectively around the current location of the vehicle.

The density of information in the home area may be differed from the density of the information outside the home area. Specifically, the in-vehicle device 10 may store detailed, i.e., high-density home area map image, and may store coarse, i.e., low-density map image outside the home area. In this way, the in-vehicle device may prioritize the home area map image to the map image outside the home area. Information attributed to the image data, such as POIs, outside the home area may be reduced compared with information attributed to the home area image data, thereby to prioritize information in the home area to information outside the home area.

(Navigation Operation)

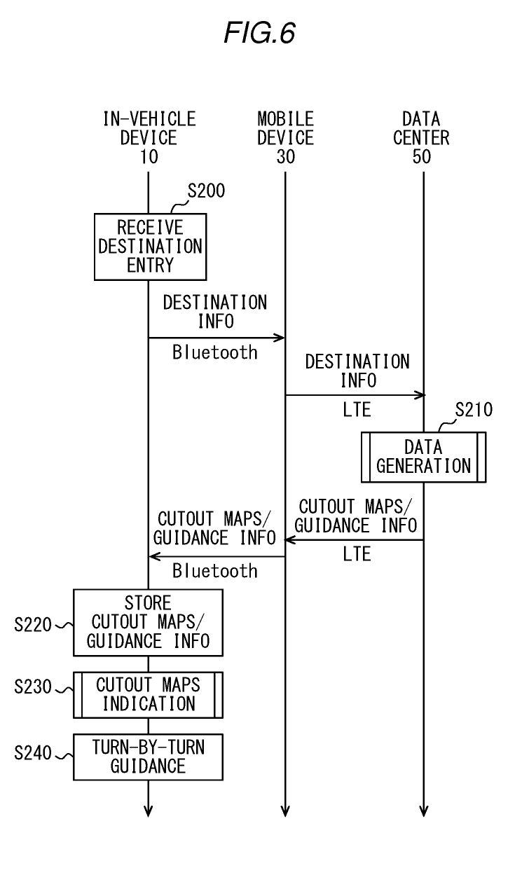

As follows, a navigation operation will be described. As shown in FIG. 6, at S200, the in-vehicle device 10 may receive entry of a destination by a user. Specifically, the user may specify the destination, for example, by entering an address of the destination, by selecting the destination from a POI list, and/or by specifying the location on the map image. Subsequently, the in-vehicle device 10 sends destination information, which is on the entered destination, to the mobile device 30 via Bluetooth. The destination information is to specify the location of the destination, such as coordinates and/or an attribute of a POI.

The mobile device 30 sends the received destination information to the data center 50 via LTE. At S210, the data center 50 executes data generation to calculate a route from the current location to the destination and to generate cutout maps and guidance information, according to the current location and the destination.

Subsequently, the data center 50 sends the generated cutout maps and the guidance information to the mobile device 30 via LTE. Subsequently, the mobile device 30 sends the cutout maps and the guidance information to the in-vehicle device 10 via Bluetooth. At S220, the in-vehicle device 10 stores the received cutout maps and guidance information in the storage device 14. At S230 and S240, the in-vehicle device 10 implements cutout map indication and turn-by-turn guidance.

In this way, the cutout maps and the guidance information are instantly downloaded from the data center 50 via the mobile device 30 and stored in the in-vehicle device 10, before the in-vehicle device 10 implements the navigation operation at S230 and S240.

(Data Generation)

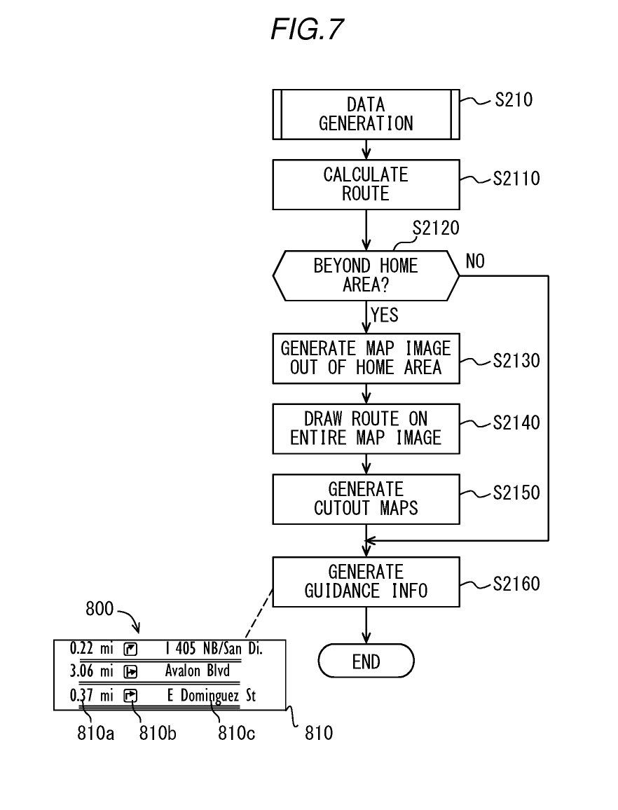

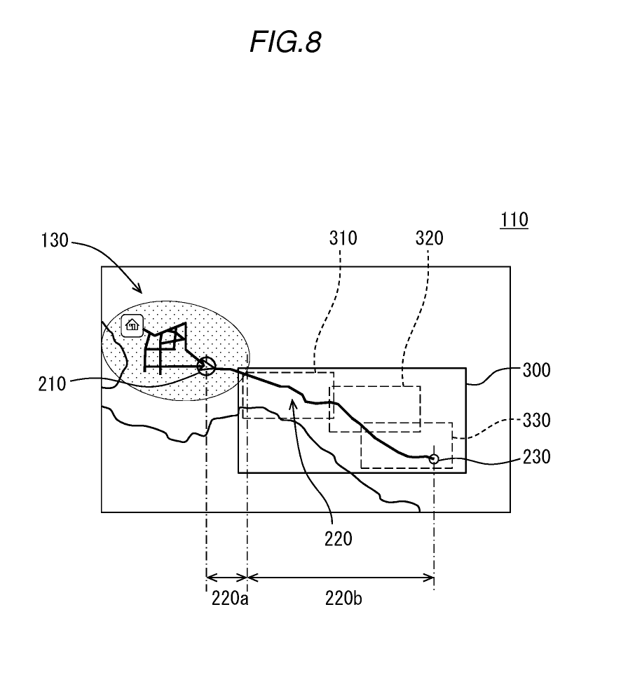

As described above, the data center 50 executes the data generation at S210 in FIG. 6. The data generation will be described with reference to FIG. 7. At S2110, the data center 50 may calculate a route from the current location of the vehicle to the destination by using, for example, Dijkstra's algorism. At S2120, the data center 50 may determine whether the calculated route is beyond the home area. On positive determination at S2120, the data center 50 may generate a small regional map image 300 (FIG. 8) outside the home area map image 130 at S2130.

Specifically, as shown in FIG. 8, a calculated route 220 may extend from the current location 210 of the vehicle, which is inside the home area map image 130, to the destination 230, which is outside the home area map image 130. The small regional map image 300 may be a part of the regional map 110. The small regional map image 300 may be adjacent to or partially overlap with the home area map image 130. The calculated route 220 may include an in-home route 220a, which is inside the home area map image 130, and an out-home route 220b, which is outside the home area map image 130. The data center 50 may define the small regional map image 300 as a section of the regional map 110 to include the destination 230 and the out-home route 220b. That is, the data center 50 may clip the small regional map image 300 from the regional map 110. The small regional map image 300 may be a raw image (bitmap data) or may be in a specific compressed format.

In FIG. 7, at S2140, the data center 50 draws the calculated route 220 onto the small regional map image 300. Specifically, the data center 50 may embed the calculated route 220 in the small regional map image 300. For example, the data center 50 may draw the calculated route 220 directly onto the small regional map image 300 by replacing original image data corresponding to the calculated route 220 with a bold and colored line image representing the calculated route 220. The data center 50 may further convert the small regional map image 300 embedded with the calculated route 220 into a compressed data in a specific compressed format, such as in JPEG format or in PNG format.

(Generation of Cutout Map Image)

At S2150 in FIG. 7, the data center 50 may generate cutout images 310, 320, 330 (FIG. 8). Specifically, with reference to FIG. 8, the data center 50 extracts multiple cutout map images 310, 320, 330 from the small regional map image 300. Each of the cutout map images 310, 320, 330 includes a part of the out-home route 220b, respectively. In the example of FIG. 8, adjacent two cutout map images 310, 320, 330 may overlap one another. Specifically, for example, the cutout map image 310 may include a part of the out-home route 220b included in the adjacent cutout map image 320. The cutout map images may be evenly divided or may be unevenly divided, and the size of each cutout image may be determined, in consideration of, for example, number of POIs included in each divided cutoff images, an actual area size and/or complexity of traffic on the calculated road.

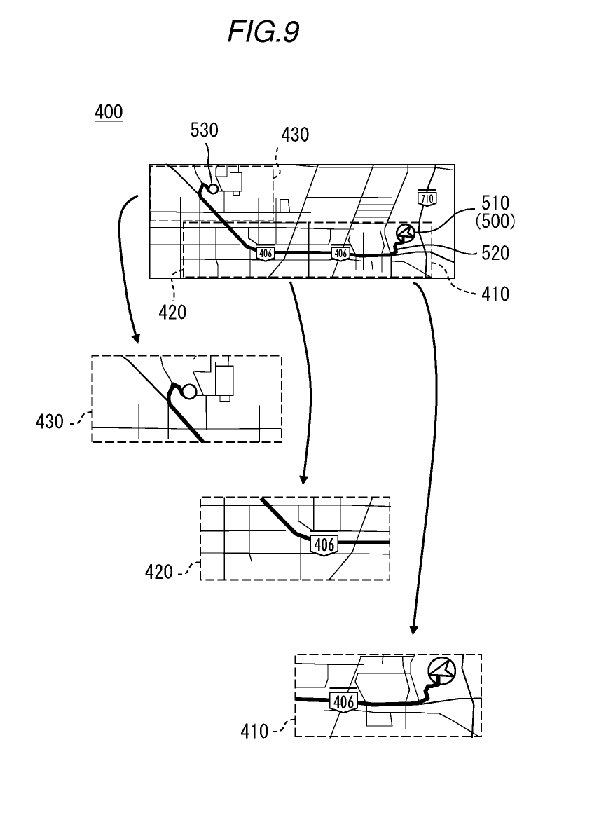

In another example of FIG. 9, the data center 50 may divide the small regional map image 400 into multiple cutout map images 410, 420, 430. In the example of FIG. 9, adjacent two cutout map images 410, 420, 430 may not overlap one another. That is, adjacent two cutout map images 410, 420, 430 may be divided at the boundary therebetween. Each of the cutout map images 410, 420, 430 includes a part of a calculate route 520, respectively. The calculate route 520 extends from a departure (start point) 510 of the vehicle to a destination 530.

In FIG. 7, at S2160, the data center 50 may generate the guidance information. Specifically, the data center 50 may generate, as guidance information, a turn-by-turn list 800 along with the calculated route. The turn-by-turn list 800 may include listed on-road event items 810 each including a combination of a distance 810a, a corner icon 810b, and a street name 810c. The guidance information may include voice messages corresponding to the on-road event items 810.

(Cutout Map Indication)

As described above, the in-vehicle device 10 may execute the cutout map indication at S230 in FIG. 6. The cutout map indication will be described with reference to FIGS. 9 to 11. As described with reference to FIG. 9, the cutout maps 410, 420, 430 may be clipped out of the small regional map image 400.

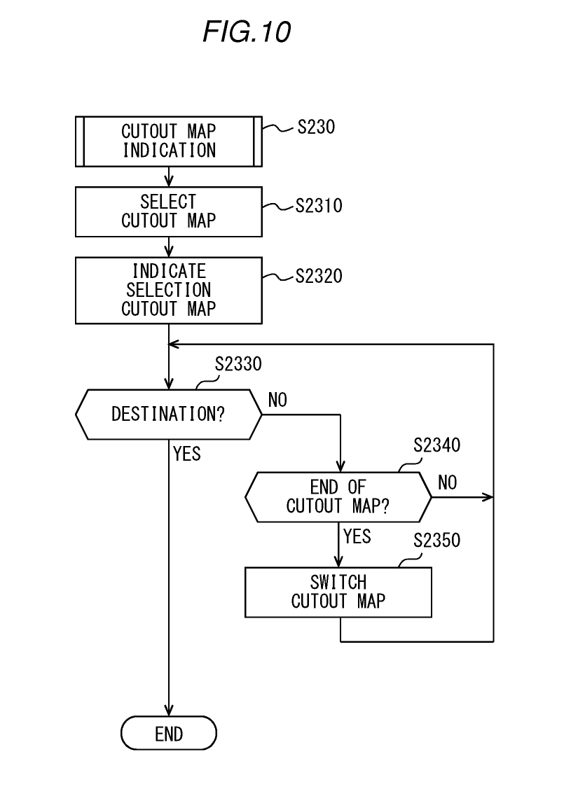

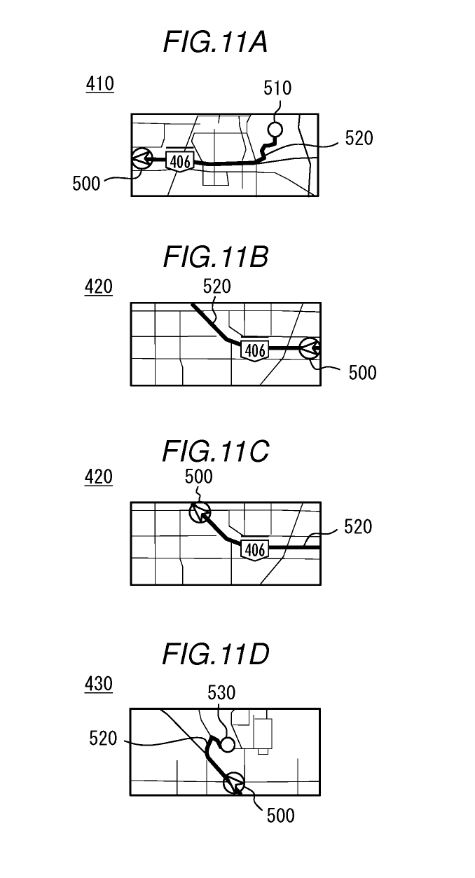

At S2310 in FIG. 10, the in-vehicle device 10 may select one of the cutout maps 410, 420, 430. As shown in FIG. 11A, the in-vehicle device 10 may initially select the cutout map 410, which includes the departure 510. At S2320 in FIG. 10, the in-vehicle device 10 indicates the selected cutout map 410. FIG. 11A shows the indicated cutout map 410. The in-vehicle device 10 also indicates a location mark 500 representing the current location of the vehicle travelling from the departure 510 along the calculated route 520 in the cutout map 410. As the vehicle travels, the location mark 500 moves on the cutout map 410.

At S2330 in FIG. 10, the in-vehicle device 10 determines whether the vehicle arrives at the destination 530. On negative determination at S2330, the processing proceeds to S2340. At S2340, the in-vehicle device 10 determines whether the location mark 500 reaches an end of the cutout map 410. In FIG. 11A, the location mark 500 moves along the calculated route 520 leftward and almost reaches an end of the cutout map 410 on the left side. When the location mark 500 reaches the end of the cutout map 410 in FIG. 11A, S2340 in FIG. 10 makes a positive determination. In this case, the processing proceeds to S2350 at which the in-vehicle device 10 switches indication of the cutout map 410 to indication of the cutout map 420, which is adjacent to the end in the cutout map 410. That is, the cutout map 410 being presently indicated as shown in FIG. 11A is switched to the cutout map 420 of FIG. 11B. Simultaneously, the location mark 500 is moved to the end of the cutout map 420 on the right side in FIG. 11B.

As the location mark 500 moves further along the calculated route 520, as shown in FIG. 11C, the location mark 500 again approaches an end of the cutout map 420 on the upper side. When the location mark 500 reaches the end of the cutout map 410 in FIG. 11C, S2340 in FIG. 10 again makes a positive determination. In this case, the processing proceeds to S2350 at which the in-vehicle device 10 switches the cutout map 420 to the cutout map 430 in FIG. 11D. The cutout map 430 is adjacent to the end in the cutout map 420. Simultaneously, the location mark 500 is moved to the end in the cutout map 430 on the lower side in FIG. 11D. As the vehicle 500 travels further along the calculated route 520, and when the vehicle 500 reaches the destination 530, S2330 makes a positive determination. Thus, the processing of FIG. 10 ends.

(Turn-by-Turn Guidance)

The in-vehicle device 10 may be configured to perform the turn-by-turn guidance to notify the user of on-road events each requiring the user to manipulate the vehicle. During the turn-by-turn guidance, the in-vehicle device 10 may indicate the listed on-road event items 810 (FIG. 7) on the display 11 in addition to the relevant cut-out map image 410, 420, 430 and the calculated route 520, as the vehicle travels. Each of the listed on-road event items 810 may include the distance 810a, the corner icon 810b, and the street name 810c. The distance 810a may represent a distance to a place, such as an intersection, at which an on-road event occurs. The corner icon 810b may represent the on-road event, such as a right/left turn at the intersection, and/or changing a lane on a highway. The street name 810c may represent, for example, a next destination, subsequent to the on-road road event. The in-vehicle device 10 may audibly guide the user of each on-road event with voice uttered from the speaker 16 and may visually guide the user by showing a message on the display 11.

(Operation Effect)

As described above, the in-vehicle device 10 may download and may utilize the map image selectively for the home area relevant to each individual user. That is, the in-vehicle device 10 may define a user-specific map area as the home area and may selectively download the home area map image. The present configuration may enable to reduce or to minimize a data volume of the downloaded map image, compared with a configuration to store large map data of an entire region such as entire United States. Thus, the present configuration may not require a long time for transmission of large map data.

As described above, the in-vehicle device 10 may initially download images of the limited home area defined based on user's daily activity area including the user's home and the user's working place between which the user daily commutes. In this way, the present configuration may effectively select the limited home area for individual user and may enable a one-to-one service (personalized service).

As described above, the in-vehicle device 10 may initially download images of the limited home area in a specific compressed format, such as in JPEG format or in PNG format. In this case, the download images may simply include compressed graphic data without attribute data. The present configuration may effectively reduce the data volume of the downloaded image.

According to the present disclosure, the in-vehicle device 10 may download and update the map image automatically on a regular basis without requiring a user to manipulate user's cell phone and/or the in-vehicle device 10. Thus, the system enables to maintain freshness of the map data updated regularly. The present configuration may download selectively the home area map image with a reduced data volume. Therefore, even when the home area map is modified and updated frequently, the data volume downloaded by the in-vehicle device 10 may be restricted within a small volume. In addition, the automatic update of the map data may enable to secure an accuracy of the home area map.

As described above, the data center 50 may send the generated cutout map and the guidance information through the mobile device 30 to the in-vehicle device 10. According to the present disclosure, the in-vehicle device 10 may complete download of the map images and the guidance information and may store the map images and the guidance information before the navigation operation. In this way, the in-vehicle device 10 may be enabled to continue indication of the map images while continuing the turn-by-turn guidance, even if the vehicle travels in an area where the mobile device 30 cannot communicate with the data center 50 via LTE. That is, even when the long-distance communications is disrupted or is weak in performance, the in-vehicle device 10 is enabled to continue the navigation operation and the turn-by-turn guidance.

The in-vehicle device 10 may initially download images of the cutout maps in a specific compressed format, such as in JPEG format or in PNG format. In this case, the download images may simply include graphic data without attribute data. The present configuration may effectively reduce the data volume of the downloaded image.

The data center 50 may draw the calculated route on the map image directly and sends the map image to the in-vehicle device 10. The present configuration further reduces the total data volume of the map image and the calculated route, compared with the case where the map image and the calculated route are separately sent to the in-vehicle device 10.

The in-vehicle device 10 may download the home area map image from the local equipment 90 vie the short-distance communications such as WiFi when communicable with the local equipment 90. The present configuration may reduce the data volume transmitted via the long-distance communications such as LTE.

### Second Embodiment

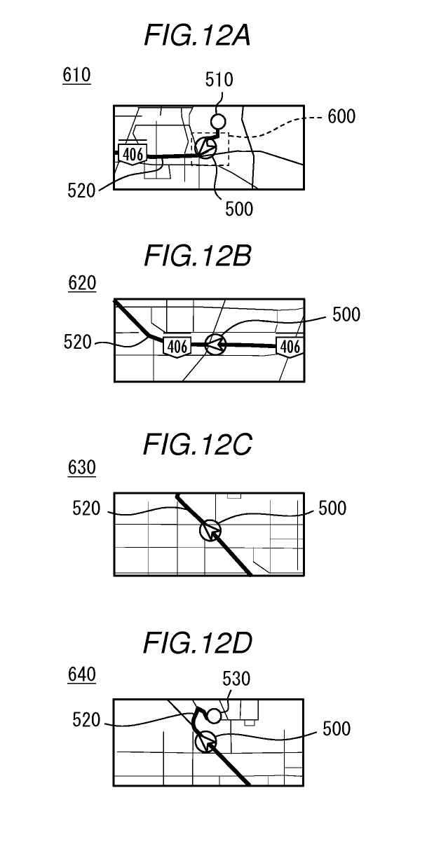

As shown in FIGS. 12A to 12D, the data center 50 may generate cut-out map images 610, 620, 630, 640, such that the location mark 500 of the vehicle stays substantially at the center of the cutout map image presently indicated, while the cutout map image moves, i.e., scrolls and/or turns, as the vehicle travels along the calculated route. In this way, the cutout map image is indicated continuously and seamlessly. For example, a region 600 may be defined to surround the vehicle 500, and the cutout image 610 may be scrolled when the vehicle 500 moves beyond the region 600. The sequential cut-out map images 610, 620, 630, 640 may be downloaded as separate images. The sequential cut-out map images 610, 620, 630, 640 may be downloaded as aggregation of images along the calculated route 520. In this case, the in-vehicle device 10 may divide the aggregation of images into the sequential cut-out map images 610, 620, 630, 640. The cut-out map images 610, 620, 630, 640 are example and may further include cut-out map images to interpolate between the cut-out map images 610, 620, 630, 640.

### Other Embodiments

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

The mobile device 30 and/or the in-vehicle device 10 may be a smart phone, a cellular phone, a portable data assistant (PDA), a portable navigation device (PND), a tablet, a laptop PC, a handheld video game console, and/or the like. The mobile device 30 may function as the in-vehicle device 10. In this case, the mobile device 30 may accept data entry by the user, may exchange information with the data center 50, and may implement the indication of the map image and the turn-by-turn guidance. In this case, the in-vehicle device 10 may be omitted. The in-vehicle device 10 may function as the mobile device 30. In this case, the in-vehicle device 10 may accept data entry by the user, may exchange information with the data center 50, and may implement the indication of the map image and the turn-by-turn guidance. In this case, the mobile device 30 may be omitted. The in-vehicle device 10 may have a part of the functions of the mobile device 30, such as the acceptance of data entry by the user, exchanging information with the data center 50, the indication of the map image, and the turn-by-turn guidance. The mobile device 30 may have a part of the functions of the in-vehicle device 10.

The in-vehicle device 10 may be configured to perform the long-distance communications. In this case, the in-vehicle device 10 may be configured to communicate directly with the data center 50 and to receive the cutout map image and the guidance information directly from the data center 50.

The in-vehicle device 10 may be communicative with the local equipment 90 via the short-distance communications when the in-vehicle device 10 is in a communicative range with the local equipment 90.

In the example of FIG. 2, the mobile device 30 may send the received home area information to the local equipment 90 via WiFi, and the local equipment 90 may send the received home area information to the data center 50 via Internet.

In the example of FIG. 6, the mobile device 30 may receive entry of the destination from the user and may send the destination information to the data center 50. The mobile device 30 may send the destination information to the local equipment 90 (FIG. 2) via WiFi, and the local equipment 90 may send the destination information to the data center 50 via Internet.

In addition or alternatively, the above-described configurations may further incorporate one of or combinations of the following features.

The mobile device 30 may be configured to store all map image in its storage device transmitted from the data center 50 once and to transmit the all map image to the in-vehicle device 10. Alternatively or in addition, the mobile device 30 may be configured successively to relay (stream) a part of map image from the data center 50 to the in-vehicle device 10.

The communicator 18 of the in-vehicle device 10 and/or the communicator 38 of the mobile device 30 may have wired communications communicative with an external device via a cable.

The in-vehicle device 10 may have a connection bus such as a universal serial bus (USB) connective with an external device to exchange data such as map data. The in-vehicle device 10 may be equipped with an external storage device such as DVD drive to download various data such as map data. The in-vehicle device 10 may be configured to store, for example, an entire US or North America, in its storage. The in-vehicle device 10 may be configured to download the entire map using a DVD with new map data or by connecting the device to a PC via a USB cable.

The in-vehicle device 10 and/or the mobile device 30 may be configured not to store map data and may be configured to keep communication with the data center 50 via the short-distance communications and/or the long-distance communications. In this case, the in-vehicle device 10 may keep receiving guidance information and the map image(s) via the mobile device 30 from the data center 50 to display the guidance information and the map image(s). The system may keep the user up-to-date about the best route to the destination, and may update the calculated route according to changing factors such as traffic and road conditions.

What is claimed is:

1. A navigation device comprising:
a controller configured to retrieve a home area information related to a home area of a user;
a communicator configured to download a home area map image, which is generated according to the home area information to exclude a map image out of the home area;
a storage configured to store the home area map image; and
a display configured to indicate the home area map image.

2. The navigation device according to claim 1, wherein
the controller is further configured to learn the home area information by sampling behavior of the user.

3. The navigation device according to claim 1, wherein
the controller is further configured to learn the home area by learning a home of the user and a working place of the user.

4. The navigation device according to claim 1, wherein
the communicator is further configured to download the home area map image automatically without an operation of a user.

5. The navigation device according to claim 1, wherein
the communicator is further configured to download the home area map image on determination that the communicator is communicable via short-distance communications.

6. The navigation device according to claim 1, wherein
the storage is further configured to store a wide-area map image, and
the display is further configured to switch indication of the home area map image to indication of the wide-area map image when being out of the home area.

7. The navigation according to claim 1, wherein
the controller is further configured to receive a destination,
the communicator is further configured to download at least one cutout image when the destination is out of the home area map image, wherein the at least one cutout image is substantially out of the home area map image, wherein the at least one cutout image includes at least a part of a route to the destination, and
the display is further configured to indicate the cutout image.

8. The navigation device according to claim 7, wherein
the controller is further configured to implement navigation to cause the display:
to indicate the home area image when being in the home area; and
to switch indication of the home area image to indication of the cutout image, when being out of the home area, without causing the communicator further to download a cutout image during the navigation.

9. A navigation device comprising:
a controller configured to receive a destination;
a storage configured to store a map image;
a communicator configured to download at least one cutout image when the destination is out of the map image, wherein the at least one cutout image is substantially out of the map image, wherein the at least one cutout image includes at least a part of a route to the destination; and
a display configured to indicate the cutout image.

10. The navigation device according to claim 9, wherein
the controller is further configured to implement navigation to cause the display to indicate the cutout image, without causing the communicator further to download a cutout image during the navigation, and
the communicator is further configured to download the at least one cutout image before the navigation.

11. The navigation device according to claim 9, wherein
the controller is further configured to implement navigation to cause the display to indicate the cutout image and further to display a guidance image according to a guidance information, without causing the communicator further to download a cutout image and a guidance information, and
the communicator is further configured to download the at least one cutout image and the guidance information before the navigation.

12. The navigation device according to claim 9, wherein
the display is further configured to indicate a location mark in the at least one cutout image,
the at least one cutout image includes a plurality of cutout images, and
the display is further configured, when the location mark moves to reach an end of one of the cutout images, to switch indication of the one of the cutout images to an other of the cutout images.

13. The navigation device according to claim 9, wherein
the display is further configured to indicate a location mark, and
the display is further configured to move the at least one cutout image to indicate the location mark substantially at a center in the at least one cutout image.

14. The navigation device according to claim 9, wherein
the at least cutout image is a part of a wide-area map image,
the at least cutout image is in a compressed format, and
at least a part of the route is embedded in the cutout image.

15. The navigation device according to claim 9, wherein
the cutout image partially overlaps with the home area map image and includes a map image out of the home area map image, or
the cutout image is completely out of the home area map image and includes a map image out of the home area map image.

16. A navigation system comprising:
a device configured to receive a home area information related to a home area of a user;
a data center configured to receive the home area information from the device and to generate a home area map image according to the home area information to exclude a map image out of the home area; wherein
the device is further configured:
to download the home area map image from the data center;
to store the home area map image; and
to indicate the home area map image.

17. The navigation system according to claim 16, wherein
the data center is further configured to extract the home area map image from a wide-area map image and to form the home area map image in a compressed format.

18. The navigation system according to claim 16, further comprising:
a mobile device configured to:
receive the home area information from the device via short-distance communications; and
send the home area information to the data center via long-distance communications.

19. The navigation system according to claim 16, wherein
the device is further configured to receive a destination,
at least one of the device and the data center is further configured to calculate a route to the destination, and
the data center is further configured to generate at least one cutout image when the destination is out of the home area map image, wherein the at least one cutout image is substantially out of the home area map image, wherein the at least one cutout image includes at least a part of the route.

20. The navigation system according to claim 19, wherein
the at least one cutout image includes a plurality of cutout images, and
the data center is further configured to generate the cutout images along the route.

21. The navigation system according to claim 19, wherein
the data center is further configured to extract the at least one cutout image from a wide-area map image in a compressed format.

22. The navigation device according to claim 19, wherein
the device is further configured to implement navigation to indicate the at least one cutout image, without further download of a cutout image during the navigation, and
the device is further configured to download the at least one cutout image before the navigation.
